(19) United States
(12) Patent Application Publication
(10) Pub. No.: US 2025/0175698 A1
(43) Pub. Date: May 29, 2025

(54) CONTROL APPARATUS, IMAGE PICKUP APPARATUS, LENS APPARATUS, CONTROL METHOD, AND STORAGE MEDIUM

(71) Applicant: CANON KABUSHIKI KAISHA, Tokyo (JP)

(72) Inventors: TORU MATSUMOTO, Tochigi (JP); YUICHIRO KATO, Tochigi (JP); MASAYASU MIZUSHIMA, Tochigi (JP); TOSHIMUNE NAGANO, Saitama (JP); AKINO MORIYOSHI, Tochigi (JP)

(21) Appl. No.: 19/039,105

(22) Filed: Jan. 28, 2025

Related U.S. Application Data
(63) Continuation of application No. PCT/JP2023/023903, filed on Jun. 28, 2023.

(30) Foreign Application Priority Data
Aug. 12, 2022 (JP) 2022-128588

(51) Int. Cl. H04N 23/67; G03B 13/32; H04N 23/61

(52) U.S. Cl. CPC H04N 23/67; G03B 13/32; H04N 23/61

(57) ABSTRACT

A control apparatus that is used for a camera system that includes an image pickup apparatus including an image sensor, and a lens apparatus including an optical system including at least one optical member configured to tilt a focal plane relative to an imaging surface of the image sensor includes a processor configured to acquire first position information and second position information based on an instruction by a user, and construct the focal plane from the first position information, the second position information, and information that is not specified by the user.

### CROSS-REFERENCE TO RELATED APPLICATIONS

This application is a Continuation of International Patent Application No. PCT/JP2023/023903, filed on Jun. 28, 2023, which claims the benefit of Japanese Patent Application No. 2022-128588, filed on Aug. 12, 2022, which is hereby incorporated by reference herein in their entirety.

### BACKGROUND

### Technical Field

The present disclosure relates to a control apparatus, an image pickup apparatus, a lens apparatus, a control method, and a storage medium.

### Description of Related Art

Optical systems having a tilt effect that tilts a focal plane so as to focus on an object plane tilted relative to an optical axis of an imaging optical system have conventionally been known.

Japanese Patent Laid-Open No. 2006-78756 discloses a method for calculating tilt angles in the vertical and horizontal directions. Japanese Patent Laid-Open No. 2021-33189 discloses a tilt drive method using the in-focus levels of two areas.

The calculation method disclosed in Japanese Patent Laid-Open No. 2006-78756 cannot calculate a tilt angle in a direction other than the vertical and horizontal directions, and thus may not set a proper focal plane in driving in an oblique direction, for example. The tilt drive method disclosed in Japanese Patent Laid-Open No. 2021-33189 is silent about the use of information other than the in-focus levels of the two areas, and thus may not set a desired focal plane in a case where the two areas are close to each other.

### SUMMARY

A control apparatus according to one aspect of the disclosure is used for a camera system that includes an image pickup apparatus including an image sensor, and a lens apparatus including an optical system including at least one optical member configured to tilt a focal plane relative to an imaging surface of the image sensor. The control apparatus includes a processor configured to acquire first position information and second position information based on an instruction by a user, and construct the focal plane from the first position information, the second position information, and information that is not specified by the user. An image pickup apparatus and a lens apparatus having the above control apparatus also constitute another aspect of the disclosure. A control method corresponding to the above control apparatus and a storage medium storing a program that causes a computer to execute the above control method also constitute another aspect of the disclosure.

Further features of the disclosure will become apparent from the following description of embodiments with reference to the attached drawings.

### BRIEF DESCRIPTION OF THE DRAWINGS

FIGS. 1A and 1B are sectional views of a camera system according to each embodiment.

FIG. 2 is a flowchart illustrating a control method of a lens CPU according to each embodiment.

FIG. 3 is a block diagram of the camera system according to each embodiment.

FIGS. 4A, 4B, and 4C explain the Scheimpflug principle in each embodiment.

FIG. 5 explains an object plane in space based on an image sensor in each embodiment.

FIGS. 6A, 6B, 6C, 6D, and 6E explain tilt imaging in a first embodiment.

FIG. 7 is a flowchart illustrating tilt imaging in the first embodiment.

FIGS. 8A, 8B, 8C, and 8D explain tilt imaging in a second embodiment.

FIGS. 9A and 9B explain tilt imaging in a third embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

### First Embodiment

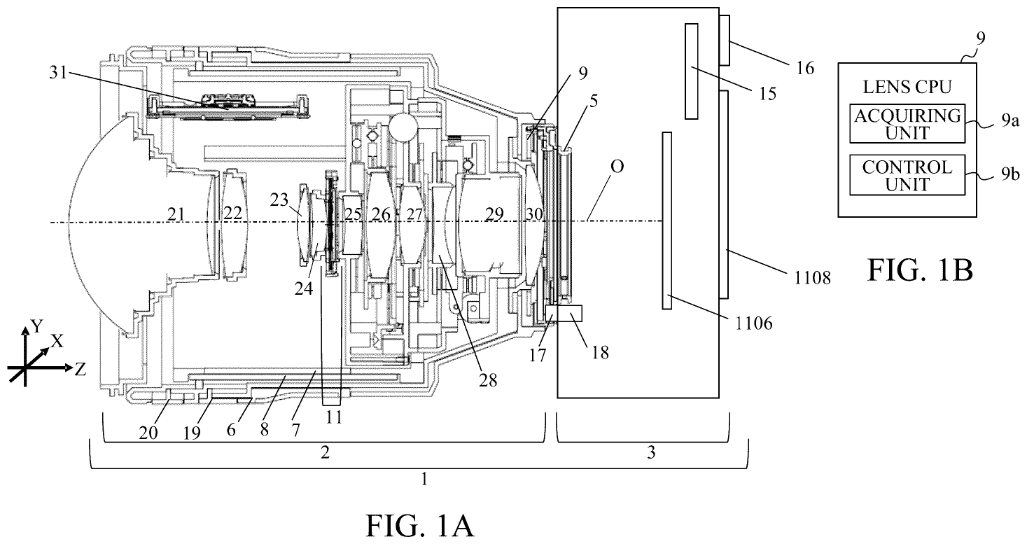

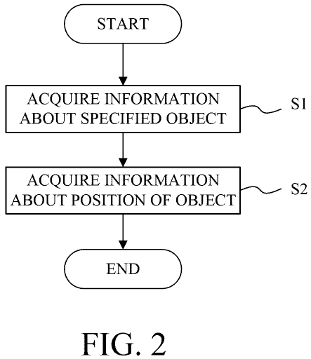

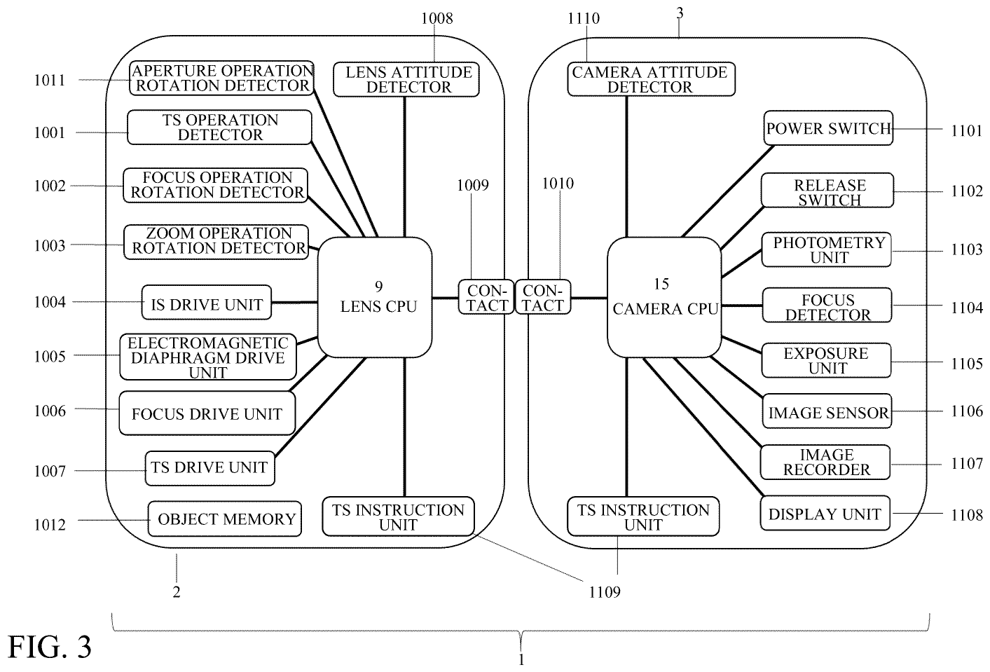

Referring now to FIGS. 1A to 3, a description will be given of a camera system (imaging system) 1 according to a first embodiment of the present disclosure. FIG. 1A is a sectional view of the camera system 1, and FIG. 1B is a block diagram of a lens CPU 9. FIG. 2 is a flowchart illustrating a control method of the lens CPU 9. FIG. 3 is a block diagram of the camera system 1.

As illustrated in FIGS. 1A and 3, the camera system 1 includes a lens apparatus 2 and a camera body (image pickup apparatus) 3. The lens apparatus 2 and the camera body 3 are connected via a mount 5 provided on the lens apparatus 2 and a mount (not illustrated) provided on the camera body 3, and can communicate with each other via a lens communication unit 17 provided in the lens apparatus 2 and a camera communication unit 18 provided in the camera body 3. The lens communication unit 17 and the camera communication unit 18 each include contacts 1009 and 1010 for supplying power from the camera body 3 to the lens apparatus 2. In this embodiment, a vertical direction (gravity direction) in FIGS. 1A and 1B is defined as a Y-axis direction, a direction parallel to an optical axis O of an optical system included in the lens apparatus 2 is defined as a Z-axis direction, and a direction orthogonal to the Y-axis direction and the Z-axis direction is defined as an X-axis direction.

The camera body 3 includes an image sensor 1106, a display unit 1108, a camera CPU 15, and a (view) finder 16. The camera CPU 15 controls a shutter (not illustrated) to expose an image formed through the lens apparatus 2 onto the image sensor 1106 for an arbitrary period, and the image can be captured. The display unit 1108 displays the captured image and a setting screen for changing various settings of the camera system 1. In this embodiment, the display unit 1108 is provided on the rear surface of the camera body 3 and has a touch panel function. The user can check the captured image and input a line of sight (visual line) by peeping through the finder 16.

The lens apparatus 2 includes an optical system, a zoom operation ring 6, a guide barrel 7, a cam barrel 8, a lens CPU 9, and an aperture mechanism 11. The optical system (imaging optical system) includes a first lens unit 21, a second lens unit 22, a third lens unit 23, a fourth lens unit 24, a fifth lens unit 25, a sixth lens unit 26, a seventh lens unit 27, an eighth lens unit 28, a ninth lens unit 29, and a tenth lens unit 30. In this embodiment, by moving at least one lens unit (optical member) included in the optical system, at least one of a tilt effect that tilts the focal plane relative to the imaging surface of the image sensor 1106 and a shift effect that moves the imaging range can be obtained.

Each lens unit is held by a lens barrel having a cam follower. The cam follower is engaged with a linear groove parallel to the optical axis O provided on the guide barrel 7 and a groove tilted relative to the optical axis O provided on the cam barrel 8. When the zoom operation ring 6 rotates, the cam barrel 8 rotates, and the arrangement of each lens in the Z-axis direction changes. Thereby, a focal length of the lens apparatus 2 changes. The focal length of the lens apparatus 2 can be detected by an unillustrated zoom position detector configured to detect a rotation amount of the zoom operation ring 6. The lens CPU 9 changes an aperture diameter (F-number) of the optical system by controlling the aperture mechanism 11 configured to adjust a light amount. The lens CPU 9 changes an aperture diameter of the optical system by controlling the aperture mechanism 11. In this embodiment, each lens unit may include one or more lenses.

The second lens unit 22 is a focus unit (focus member) that performs focusing by moving in the Z-axis direction. The lens CPU 9 controls the second lens unit 22 via a vibration actuator 31 using a detection signal from a detector configured to detect a moving amount of the second lens unit 22.

The lens apparatus 2 includes a tilt member that tilts the focal plane relative to the imaging surface of the image sensor 1106. In this embodiment, the tilt member includes a sixth lens unit (first optical member) 26 and an eighth lens unit (second optical member) 28 that can move in a direction orthogonal to the optical axis O. In this embodiment, a tilt effect or a shift effect can be obtained by moving the sixth lens unit 26 and the eighth lens unit 28 in a direction orthogonal to the optical axis O. More specifically, in a case where both the sixth lens unit 26 and the eighth lens unit 28 have positive or negative refractive powers, the sixth lens unit 26 and the eighth lens unit 28 move in opposite directions to generate a tilt effect. Conversely, the sixth lens unit 26 and the eighth lens unit 28 move in the same direction to generate a shift effect. On the other hand, in a case where the sixth lens unit 26 and the eighth lens unit 28 have refractive powers of different signs, positive and negative, the sixth lens unit 26 and the eighth lens unit 28 move in the same direction to generate a tilt effect. Conversely, the sixth lens unit 26 and the eighth lens unit 28 move in opposite directions to generate a shift effect.

The lens CPU 9 controls the sixth lens unit 26 via a drive unit using a signal from an unillustrated detector configured to detect a moving amount of the sixth lens unit 26. The lens CPU 9 controls the eighth lens unit 28 via a drive unit using a signal from an unillustrated detector configured to detect a moving amount of the eighth lens unit 28. The drive unit which moves the sixth lens unit 26 and the eighth lens unit 28 is, for example, a stepping motor or a voice coil motor (VCM). The tilt effect is also available by tilting (rotating) a lens.

As illustrated in FIG. 1B, the lens CPU (control apparatus) 9 includes an acquiring unit 9a and a control unit 9b, and controls the operation of each component in the lens apparatus 2. The acquiring unit 9a acquires information about an specified object. The control unit 9b acquires information about the position of the object to construct an object plane (focal plane) based on the information about the specified object. In this embodiment, the lens CPU 9 is mounted in the lens apparatus 2, but may be configured as a control apparatus different from the lens apparatus 2. The camera CPU 15 may be configured to have at least some of the functions of the acquiring unit 9a and the control unit 9b.

The lens CPU 9 performs control as illustrated in FIG. 2. First, in step S1, the acquiring unit 9a acquires information about the specified object. Then, in step S2, the control unit 9b acquires information about the position of the object to construct an object plane based on the information about the specified object.

As illustrated in FIG. 3, the camera CPU (control apparatus) 15 includes a microcomputer, and controls the operation of each unit in the camera body 3. In a case where the lens apparatus 2 is attached to the camera body 3, the camera CPU 15 communicates with the lens CPU 9 via the lens communication unit 17 and the camera communication unit 18. Information (signal) which the camera CPU 15 transmits to the lens CPU 9 includes moving amount information about the second lens unit 22 and defocus information. The information which the camera CPU 15 transmits to the lens CPU 9 further includes attitude information on the camera body 3 based on a signal from a camera attitude detector 1110 such as an acceleration sensor. The information which the camera CPU 15 transmits to the lens CPU 9 further includes information such as object distance information based on a signal from a tilt/shift (TS) instruction unit 1109 configured to specify an object the user intends to focus on, and imaging range information which indicates a desired imaging range (field of view).

Information (signal) which the lens CPU 9 transmits to the camera CPU 15 includes, for example, optical information such as an imaging magnification of a lens, and lens function information such as zoom and image stabilization mounted on the lens apparatus 2. The information which the lens CPU 9 transmits to the camera CPU 15 may further include attitude information on the lens apparatus 2 based on a signal from a lens attitude detector 1008 such as a gyro sensor or an acceleration sensor.

A power switch 1101 is a switch that is operable by the user and used to start the camera CPU 15 and start supplying power to each actuator, sensor, etc. in the camera system 1. A release switch 1102 is a switch that is operable by the user, and includes a first stroke switch SW1 and a second stroke switch SW2. A signal from the release switch 1102 is input to the camera CPU 15. The camera CPU 15 enters an imaging preparation state in response to an input of an turning-on signal from the first stroke switch SW1. In the imaging preparation state, a photometry unit 1103 measures the object luminance, and a focus detector 1104 performs focus detection.

The camera CPU 15 calculates an aperture value of the aperture mechanism 11, an exposure amount (shutter time) of the image sensor 1106, etc. based on a photometry result by the photometry unit 1103. The camera CPU 15 determines the moving amount (including drive direction) of the second lens unit 22 based on focus information (defocus amount and defocus direction) on the optical system detected by the focus detector 1104. Information on the moving amount of the second lens unit 22 is transmitted to the lens CPU 9.

In this embodiment, as described above, by moving the sixth lens unit 26 and the eighth lens unit 28 in the direction orthogonal to the optical axis O, the tilt effect and the shift effect can be obtained. The camera CPU 15 calculates a tilt drive amount for focusing on the desired object indicated through the TS instruction unit 1109. In this embodiment, the TS instruction unit 1109 is included in the display unit 1108 having a touch panel function. The camera CPU 15 calculates a shift drive amount for changing a current imaging range to an imaging range indicated through the TS instruction unit 1109. The camera CPU 15 transmits acquired information on the drive amount to the lens CPU 9. The sixth lens unit 26 and the eighth lens unit 28 are controlled based on the information on the drive amount described above.

The number of objects specified by the TS instruction unit 1109 may be plural. Even if objects having different distances are specified, these objects can be focused as long as they are located on an object plane tilted due to the tilt effect. The TS instruction unit 1109 may be provided in the lens apparatus 2 instead of the camera body 3. The function of the TS instruction unit 1109 may be assigned to an operation unit already provided in the camera system 1.

In a case where the camera CPU 15 is set to a predetermined imaging mode, it starts controlling eccentric drive of an unillustrated image stabilizing lens, that is, the image stabilizing operation. In a case where the lens apparatus 2 does not have the image stabilizing function, the image stabilizing operation is not performed. In addition, the camera CPU 15 transmits an aperture drive command to the lens CPU 9 according to a turning-on (ON) signal input from the second stroke switch SW2, and sets the aperture mechanism 11 to the previously acquired aperture value. The camera CPU 15 transmits an exposure start command to an exposure unit 1105, and causes an unillustrated mirror to retreat or an unillustrated shutter to open. In a case where the camera body 3 is a mirrorless camera, the retreat operation is not performed. The camera CPU 15 causes the image sensor 1106 to perform a photoelectric conversion of an object image, that is, an exposure operation.

An imaging signal from the image sensor 1106 is digitally converted by a signal processing unit in the camera CPU 15, further subjected to various correction processes, and output as an image signal. The image signal (data) is stored in an image recorder 1107 such as a semiconductor memory such as a flash memory, a magnetic disk, and an optical disc.

The display unit 1108 can display an image captured by the image sensor 1106 during imaging. The display unit 1108 can display images recorded in the image recorder 1107.

A description will now be given of a control flow inside the lens apparatus 2. A focus operation rotation detector 1002 detects a rotation of a focus operation ring 19. A diaphragm operation rotation detector 1011 detects a rotation of a diaphragm operation ring 20. A zoom operation rotation detector 1003 detects a rotation of the zoom operation ring 6. An object memory 1012 stores a spatial position in the imaging range of the object indicated through the TS instruction unit 1109 (position information in space based on the image sensor 1106). Here, the spatial position is an object distance or coordinate information in a spatial coordinate system based on the image sensor 1106.

A TS operation detector 1001 includes a manual operation unit for obtaining the tilt effect and the shift effect, and a sensor configured to detect an operation amount of the manual operation unit. The IS drive unit 1004 includes a driving actuator for the image stabilizing lens that performs the image stabilizing operation, and a driving circuit for the driving actuator. In a case where the lens apparatus 2 has no image stabilizing function, the above configuration is not necessary. A focus drive unit 1006 includes the second lens unit 22 and a vibration actuator 31 configured to move the second lens unit 22 in the Z-axis direction in accordance with moving amount information. The moving amount information may be determined based on a signal from the camera CPU 15, or may be determined based on a signal output by operating the focus operation ring 19.

An electromagnetic diaphragm drive unit 1005 changes the aperture mechanism 11 to an aperture state corresponding to a specified aperture value in response to an instruction from the lens CPU 9 which has received a diaphragm drive command from the camera CPU 15 or in response to a user's instruction via the diaphragm operation ring 20. A TS drive unit 1007 moves the sixth lens unit 26 and the eighth lens unit 28 according to an instruction from the lens CPU 9 based on information on an object distance, position, and imaging range transmitted from the camera CPU 15. The lens CPU 9 controls the TS drive unit 1007 and the focus drive unit 1006 so that the TS drive unit 1007 and the focus drive unit 1006 can operate properly, in order to obtain a desired focus. The lens apparatus 2 has an optical characteristic that the focus changes even if the object distance does not change by a shift operation of the sixth lens unit 26 and the eighth lens unit 28, and the TS drive unit 1007 and the focus drive unit 1006 are controlled to operate properly in accordance with this optical characteristic.

A gyro sensor electrically connected to the lens CPU 9 is provided inside the lens apparatus 2. The gyro sensor detects an angular velocity of each of the vertical (pitch direction) shake and the horizontal (yaw direction) shake, which are the angular shakes of the camera system 1, and outputs a detected value to the lens CPU 9 as an angular velocity signal. The lens CPU 9 electrically or mechanically integrates the angular velocity signals in the pitch and yaw directions from the gyro sensor to calculate a pitch shake amount and a yaw shake amount (collectively referred to as an angular shake amount), which are displacement amounts in the respective directions.

The lens CPU 9 controls the IS drive unit 1004 based on the combined displacement amount of the above angular shake amount and the parallel (or translational) shake amount to move the unillustrated image stabilizing lens and perform angular shake correction and parallel shake correction. In a case where the lens apparatus 2 has no image stabilizing function, the above configuration is not necessary. In addition, the lens CPU 9 controls the focus drive unit 1006 based on the focus shake amount to move the second lens unit 22 in the Z-axis direction and perform focus shake correction.

Here, in the lens apparatus 2, the lens CPU 9 controls the TS drive unit 1007 based on the shake and displacement amount of the lens apparatus 2 calculated based on the output from the gyro sensor. For example, in a case where camera shake occurs during imaging with the camera body 3 held by hand, the object plane shifts relative to the object. Since the position of the object is stored in the object memory 1012 in the camera body 3, the TS drive unit 1007 can be controlled to correct camera shake and keep the object plane aligned with the object. A signal from an acceleration sensor mounted on the camera body 3 may be used to control the TS drive unit 1007. The lens apparatus 2 may include an acceleration sensor in addition to a gyro sensor.

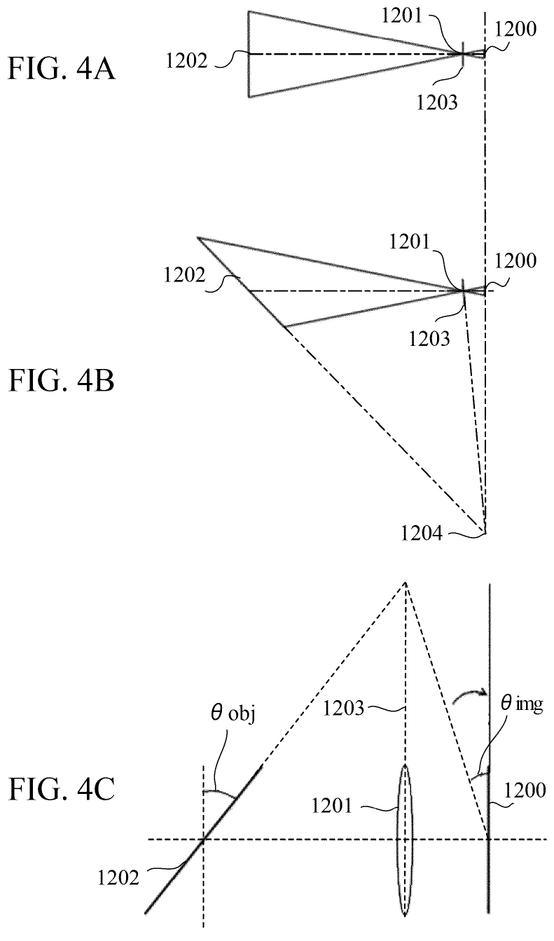

Referring now to FIGS. 4A, 4B, and 4C, a description will be given of the Scheimpflug principle. FIG. 4A illustrates an in-focus range in a case where the optical axis of the optical system 1201 is not tilted relative to the imaging surface 1200. FIG. 4B illustrates an in-focus range in a case where the optical axis of the optical system 1201 is tilted relative to the imaging surface 1200. The Scheimpflug principle is that, as illustrated in FIG. 4B, in a case where the imaging surface 1200 and a principal surface 1203 of the optical system intersect at an intersection 1204, the in-focus object plane 1202 also passes through the intersection 1204. Therefore, in a case where the optical axis of the optical system 1201 is tilted relative to the imaging surface 1200, the in-focus range on the object side is determined by the Scheimpflug principle. In a case where the object to be captured has a depth, the object plane 1202 is tilted to match the depth to achieve focusing from the front to the back of the object. On the other hand, tilting the principal surface 1203 of the optical system 1201 in the opposite direction to the tilt of the object with depth can make the object plane 1202 intersect with the depth direction of the object at an angle close to a right angle. In this case, since the in-focus range can be extremely narrowed, a diorama-style image can be obtained.

In this embodiment, as illustrated in FIG. 4C, the image plane tilt due to the decentering of the optical system 1201 is utilized to generate a tilt θobj of the object plane 1202 without tilting the imaging surface 1200 by the image plane tilt θimg. In a case where the tilt θobj of the object plane 1202 is generated by the optical system 1201, the decentering amount of the optical system 1201 and finally the composition shift increase. Accordingly, a lens designed to reduce aberration fluctuations during decentering may be decentered. In this embodiment, in order to change the tilt effect, the sixth lens unit 26 that generates the tilt of the object plane and the eighth lens unit 28 that reduces aberration fluctuations during decentering are decentered.

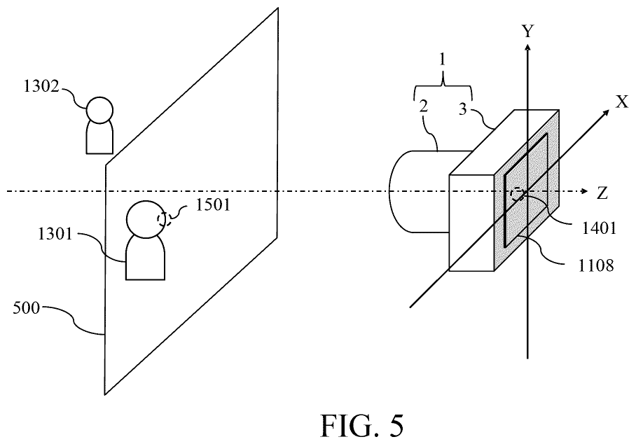

Referring now to FIG. 5, a description will be given of the object plane (focal plane 500) in space based on the image sensor 1106. FIG. 5 explains the focal plane 500 in the space based on the image sensor 1106. The camera system 1 can acquire position information in the Z-axis direction about a first object 1301 and a second object 1302 by, for example, an unillustrated focus detecting system using infrared light or a focus detecting function installed in the image sensor 1106. The camera system 1 can also obtain position information in the X-axis and Y-axis directions based on the imaging positions of the first object 1301 and the second object 1302 on the imaging surface of the image sensor 1106.

In this embodiment, the user can instruct an object by touching the display unit 1108, and thereby acquire information regarding the position of the specified object. For example, in a case where the user instructs a first point 1401, which is a point on the display unit 1108, the camera body 3 acquires a first coordinate (first position information) 1501, which is information regarding the position of the first object 1301. The acquired information is stored in the object memory 1012. An unillustrated memory in the lens apparatus 2 stores table data indicating a relationship between moving amounts and moving directions of the sixth lens unit 26 and the eighth lens unit 28, and a tilt amount of the focal plane 500 relative to the optical axis O. The camera CPU 15 and the lens CPU 9 perform calculations using the position information and table data stored in the object memory 1012, and control the sixth lens unit 26 and the eighth lens unit 28 based on the calculation results, so that the focal plane 500 is constructed. Instead of the table data, for example, a relationship between the lens moving amount and the tilt amount of the focal plane 500 may be calculated using a predetermined equation, and the sixth lens unit 26 and the eighth lens unit 28 may be controlled using the calculation results. Also, the focal plane 500 may be constructed by gradually moving the sixth lens unit 26 and the eighth lens unit 28 and determining the in-focus level of each object.

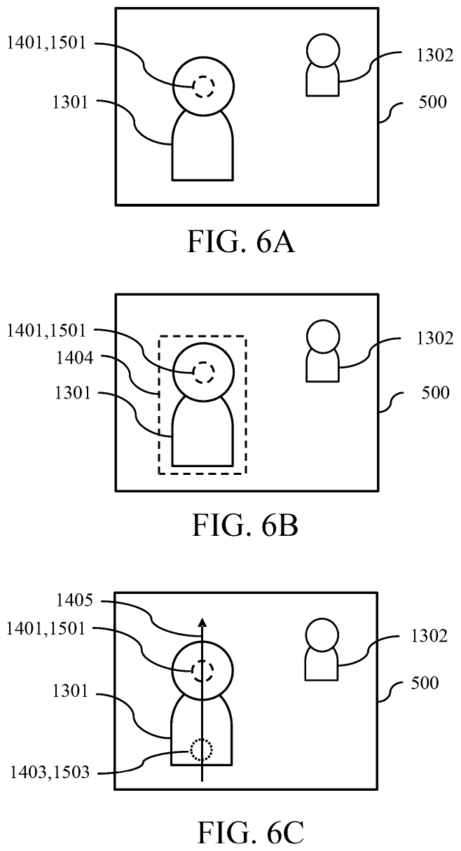

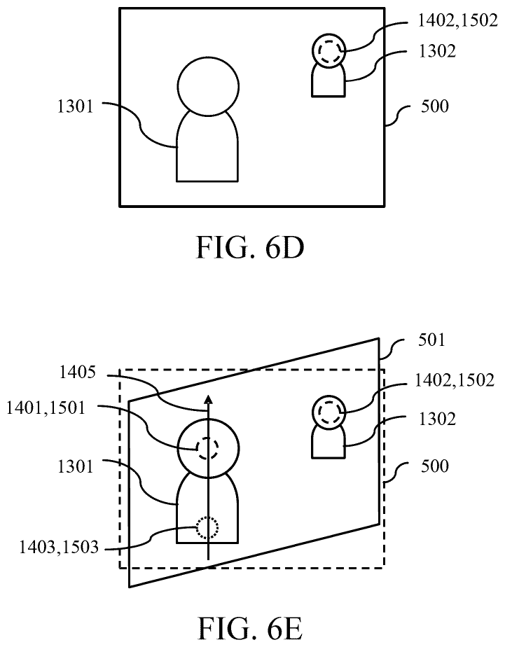

Referring now to FIGS. 6A, 6B, 6C, 6D, and 6E, a description will be given of imaging using the tilt effect in this embodiment. FIGS. 6A, 6B, 6C, 6D, and 6E explain a series of steps in tilt imaging assuming portrait imaging.

First, as illustrated in FIG. 6A, the user specifies a first point 1401 with the camera body 3 so that the first object 1301 is in focus. FIG. 6A illustrates a state in which the first object 1301 is in focus and the second object 1302 is out of focus. At this time, the camera body 3 acquires a first coordinate (first position information) 1501 based on the position information in the Z-axis direction and focal length information regarding the first point 1401 and the first object 1301, and stores it in the object memory 1012. At this time, the camera body 3 also acquires a first object range 1404 of the first object 1301, as illustrated in FIG. 6B. A method of acquiring the object range (size and area of the object) is well known, and thus a detailed description thereof will be omitted.

Next, as illustrated in FIG. 6C, the camera body 3 estimates a third point 1403 from the first object range 1404. The camera body 3 then calculates a third coordinate (third position information) 1503 based on the position information in the Z-axis direction about the first object 1301 and the position and focal length information regarding the third point 1403, and stores the third coordinate (third position information) 1503 in the object memory 1012. The third point 1403 may be selected so as to maximize a distance from the first point 1401 within the first object range 1404, but may be specified at a position away from the first point 1401 (a position different from the first point 1401). For example, in the case of capturing a person standing upright, if his face is specified as the first point, his feet may be specified as the third point.

Next, as illustrated in FIG. 6D, the user specifies the second point 1402 with the camera body 3 so that the second object 1302 is in focus. FIG. 6D illustrates a state in which the second object 1302 is in focus and the first object 1301 is out of focus. At this time, the camera body 3 acquires the second coordinate (second position information) 1502 based on the position information in the Z-axis direction and focal length information regarding the second point 1402 and the second object 1302, and stores it in the object memory 1012.

Next, the camera CPU 15 performs the calculations required to construct the focal plane 501 using the first coordinates 1501 and second coordinates 1502 specified by the user, the third coordinates 1503 estimated by the camera body 3, and the table data. Based on the result, the sixth lens unit 26, the eighth lens unit 28, and the second lens unit 22 are controlled to construct the focal plane 501. Constructing the focal plane 501 can provide tilt imaging with the first object 1301 and the second object 1302 in focus.

The user can perform tilt imaging simply by specifying two points to be in focus without specifying a third point, and thus can acquire improved convenience of tilt imaging.

In constructing the focal plane 501, if it is difficult to construct it by only moving the second lens unit 22, the sixth lens unit 26, and the eighth lens unit 28, the camera body 3 can change the in-focus range by driving the aperture mechanism 11. Thereby, the in-focus range can be enlarged or reduced, and a desired captured image can be easily obtained.

The method in this embodiment constructs the focal plane (object plane) 501 after three points, namely, the first coordinates 1501 and the second coordinates 1502 specified by the user, and the third coordinates 1503 estimated by the camera body 3 are acquired. However, as illustrated in FIGS. 6C and 6E, the focal plane 501 may be constructed by calculating a vector 1405 passing through the first coordinates 1501 and the third coordinates 1503, and rotating the object plane around the axis of the vector 1405 so that the second coordinates 1502 is in focus.

In this embodiment, the third point 1403 is estimated from the first object range 1404 of the first object 1301, and the third coordinates 1503 are obtained. However, the object range of the second object 1302 may be detected, and the third point 1403 may be estimated from the range, and the third coordinates 1503 may be obtained.

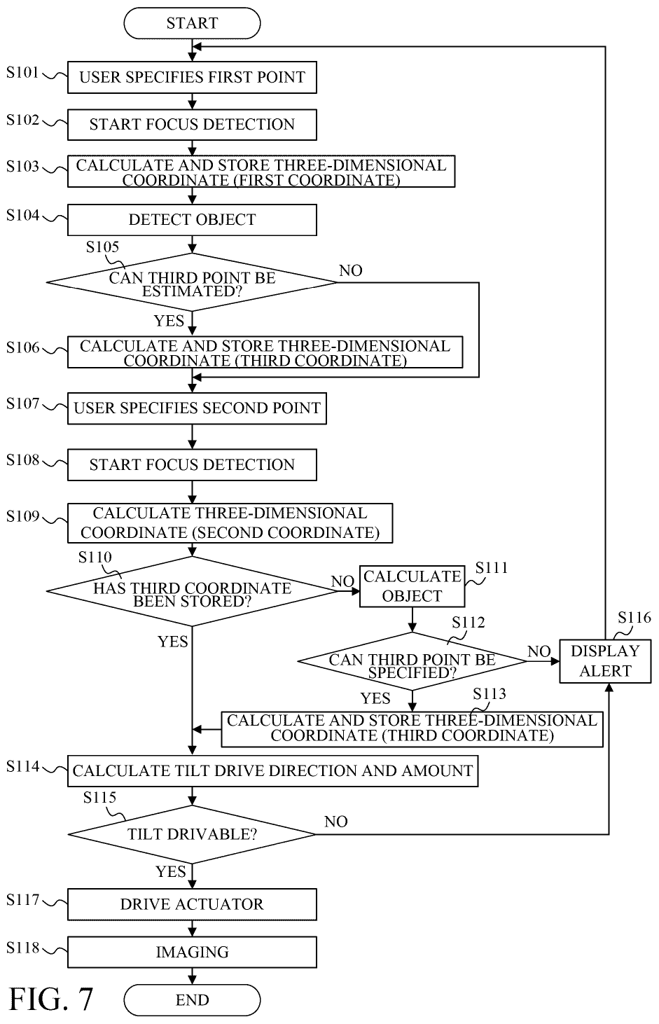

Referring now to FIG. 7, a detailed description will be given of tilt imaging (control method) in this embodiment. FIG. 7 is a flowchart illustrating tilt imaging. Each step in FIG. 7 is described as being executed by the camera CPU 15 (functions as the acquiring unit and the determining unit), but this is not limited to this example. Each step in FIG. 7 may be executed by either the camera CPU 15 or the lens CPU 9, or the camera CPU 15 and the lens CPU 9 may share and execute each step. That is, each step in FIG. 7 is executed by at least one of the camera CPU 15 and the lens CPU 9, or based on an instruction from at least one of the camera CPU 15 and the lens CPU 9. A control apparatus physically separated from the camera CPU 15 or the lens CPU 9 may be configured to execute at least some of the steps.

First, in step S101, the user specifies a first point. Next, in step S102, the camera CPU 15 acquires position information (distance information) in the Z-axis direction about the object located at the first point specified by the user, using an unillustrated focus detecting system (distance measuring unit). Next, in step S103, the camera CPU 15 acquires position information in the X-axis and Y-axis directions based on the imaging position of the object on the imaging surface of the image sensor 1106. Then, the camera CPU 15 acquires (calculates) a first coordinate (first position information) as a three-dimensional coordinate based on the position information in the X-axis and Y-axis directions and the position information in the Z-axis direction acquired in step S102, and stores it in the object memory 1012.

Next, in step S104, the camera CPU 15 detects the range (size, area) and type of the object located at the first point specified by the user in step S101 based on the object information detected from the image data output from the image sensor 1106. Next, in step S105, the camera CPU 15 determines whether or not the third point can be estimated from the range and type of the object detected in step S104. In a case where the camera CPU 15 determines that the third point can be estimated, the flow proceeds to step S106. On the other hand, in a case where the camera CPU 15 determines that the third point cannot be estimated, the flow proceeds to step S107. In step S106, the camera CPU 15 calculates the third coordinate based on the third point estimated in step S105 and the position information acquired in step S102, and stores the third coordinate in the object memory 1012.

In step S107, the user specifies the second point. Next, in step S108, the camera CPU 15 acquires position information (distance information) in the Z-axis direction about the object located at the second point specified by the user, using the unillustrated focus detecting system. Next, in step S109, the camera CPU 15 acquires position information in the X-axis and Y-axis directions from the imaging position of the object on the imaging surface of the image sensor 1106. Then, based on the position information in the X-axis and Y-axis directions and the position information in the Z-axis direction acquired in step S108, the camera CPU 15 acquires (calculates) a second coordinate (second position information), which is a three-dimensional coordinate, and stores it in the object memory 1012.

Next, in step S110, the camera CPU 15 determines whether the third coordinate has been stored. In a case where it is determined that the third coordinate has been stored, the flow proceeds to step S114. In step S114, the camera CPU 15 calculates tilt drive directions and drive amounts, and determines the tilt drive directions and drive amounts of the sixth lens unit 26, the eighth lens unit 28, and the second lens unit 22. Next, in step S115, the camera CPU 15 determines whether or not tilt drive is possible based on whether or not the tilt drive directions and drive amounts determined in step S114 exceed the movable ranges of the sixth lens unit 26 and the eighth lens unit 28. In a case where it is determined that tilt driving is possible, the flow proceeds to step S117, where the camera CPU 15 drives the sixth lens unit 26, the eighth lens unit 28, and the second lens unit 22 to construct the focal plane 501. Next, in step S118, the camera CPU 15 performs an imaging operation, stores the captured image in the image recorder 1107, and the flow ends.

On the other hand, in a case where it is determined in step S110 that the third coordinate is not stored, the flow proceeds to step S111. In step S111, the camera CPU 15 detects the range and type of the object located at the second point specified by the user in step S107 based on the object information detected from the image data output from the image sensor 1106. Next, in step S112, the camera CPU 15 determines whether or not the third point can be estimated based on the range and type of the object detected in step S111. In a case where it is determined that the third point can be estimated, the flow proceeds to step S113. In step S113, the camera CPU 15 calculates a third coordinate (third position information) which is a three-dimensional coordinate based on the third point estimated in step S112 and the position information acquired in step S109, and stores it in the object memory 1012. Then, the flow proceeds to step S114. On the other hand, in a case where it is determined in step S112 that the third point cannot be estimated, the flow proceeds to step S116. In step S116, the camera CPU 15 displays an alert to the user that the object plane cannot be constructed. Then, the flow returns to step S101, and the user specifies the first point again.

In a case where it is determined in step S115 that the tilt drive directions and drive amounts determined in step S114 exceed the movable ranges of the sixth lens unit 26 and the eighth lens unit 28, the flow proceeds to step S116. In step S116, the camera CPU 15 displays an alert to the user that the object plane cannot be constructed. Then, the flow returns to step S101, and the user specifies the first point again.

### Second Embodiment

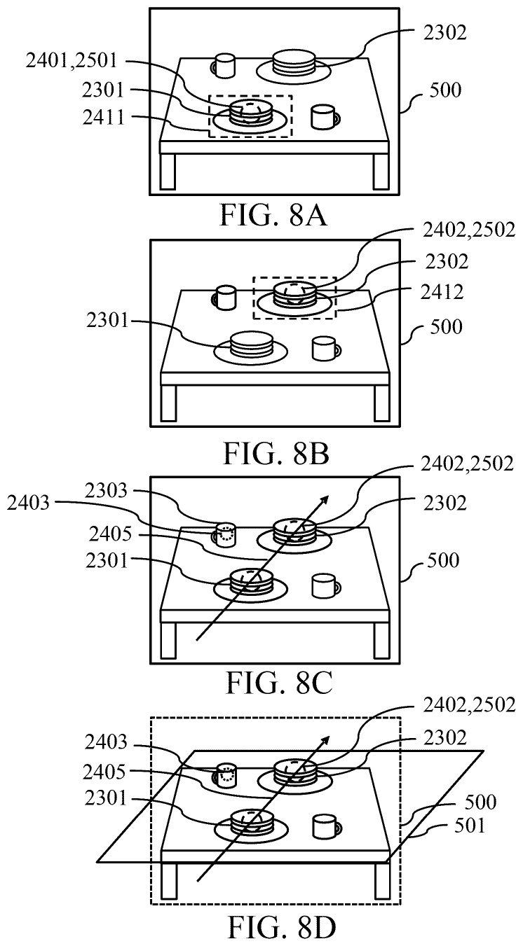

Referring now to FIGS. 8A, 8B, 8C, and 8D, a description will be given according to a second embodiment of the present disclosure. Those elements in this embodiment, which are corresponding elements in the first embodiment, will be designated by the same reference numerals, and a description thereof will be omitted.

FIGS. 8A, 8B, 8C, and 8D explain a series of steps in tilt imaging assuming still life imaging in this embodiment. First, as illustrated in FIG. 8A, the user specifies a first point 2401 with the camera body 3 so that a first object 2301 is in focus. FIG. 8A illustrates a state in which the first object 2301 is in focus and a second object 2302 is out of focus. At that time, the camera body 3 acquires a first coordinate (first position information) 2501 based on the position information in the Z-axis direction and focal length information about the first point 2401 and the first object 2301, and stores it in the object memory 1012. The camera body 3 also acquires a first object range 2411 of the first object 1301 and determines the type of object. Since the method of acquiring the object range and determining the type is well known, a detailed description thereof will be omitted.

Next, as illustrated in FIG. 8B, the user specifies a second point 2402 with the camera body 3 so that the second object 2302 is in focus. FIG. 8B illustrates a state in which the second object 2302 is in focus and the first object 2301 is out of focus. At that time, the camera body 3 acquires a second coordinate (second position information) 2502 based on the position information in the Z-axis direction and the focal length information about the second point 2402 and the second object 2302, and stores it in the object memory 1012. The camera body 3 also acquires a second object range 2412 of the second object 2302 and determines the type of object. The camera CPU 15 determines an imaging scene based on the types of the first object 2301 and the second object 2302. In this embodiment, it is determined that the imaging scene is still life imaging.

Next, as illustrated in FIG. 8C, the camera CPU 15 calculates a vector 2405 passing through the first coordinate 2501 and the second coordinate 2502. In a case where it is determined that the imaging scene is still life imaging, the camera CPU 15 changes the focal plane based on the axis of the vector 2405 to set the third point 2403 so that an in-focus range (in which an in-focus state is obtained) of the imaging range is widened (or maximized). More specifically, in FIG. 8C, the focal plane 500 is changed so that the third object 2303 is also in focus. As a result, as illustrated in FIG. 8D, the focal plane 501 in which the first object 2301, the second object 2302, and the third object 2303 are in focus is constructed.

The user can perform tilt imaging simply by specifying two points to be in focus without specifying a third point, and thus can acquire improved convenience of tilt imaging.

In this embodiment, in a case where it is determined that the imaging is still life imaging, the in-focus range of the imaging range is set to be maximized, but the focal plane 501 may be constructed so that the first object range 2411 and the second object range 2412 are in focus. In this embodiment, the vector 2405 is calculated and the focal plane is changed based on the axis of the vector 2405, but the third point 2403 may be set by previously searching for the third object 2303, the third coordinate may be calculated based on that information, and the focal plane that passes through the three coordinates may be set.

In this embodiment, the vector 2405 is calculated, and the focal plane 500 is changed around the axis of the vector 2405 to set the in-focus range of the imaging range to be maximized, but this embodiment is not limited to this example. The camera body 3 can perform imaging a plurality of times in changing the focal plane 500. The focal plane may be set by changing the focal plane within the drivable ranges of the sixth lens unit 26 and the eighth lens unit 28. The sixth lens unit 26 and the eighth lens unit 28 may be driven to the positions where the driving amounts are minimum or maximum, and imaging may be performed a plurality of times.

Thereby, a plurality of images can be acquired that are focused on the designated points of the first object 2301 and the second object 2302. As a result, the user can later select an image which are focused on the desired range, and thus can acquire more improved convenience of tilt imaging.

### Third Embodiment

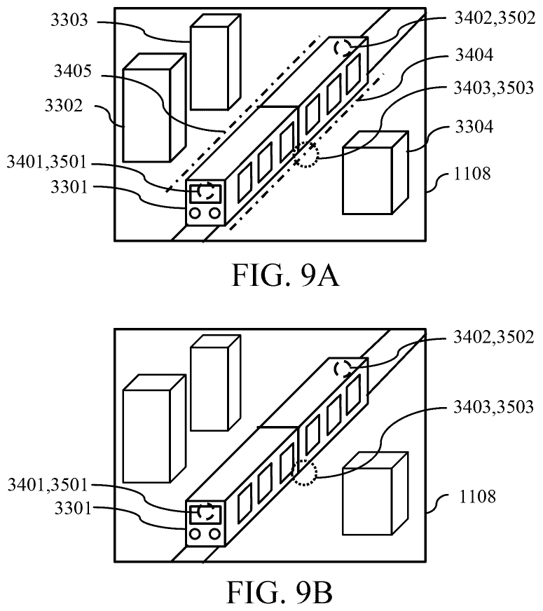

Referring now to FIGS. 9A and 9B, a description will be given of a third embodiment according to the present disclosure. Those elements in this embodiment, which are corresponding elements in the first embodiment, will be designated by the same reference numerals, and a description thereof will be omitted.

FIGS. 9A and 9B explain a series of tilt imaging flows assuming miniature imaging (diorama imaging) in this embodiment. First, the user sets the imaging mode of the camera body 3 to the miniature imaging mode. In FIG. 9A, the user specifies a first point 3401 with the camera body 3 so that an object 3301 is in focus. At that time, the camera body 3 acquires a first coordinate (first position information) 3501 based on the position information in the Z-axis direction and focal length information about the first point 3401 and the object 3301, and stores it in the object memory 1012.

Next, the user specifies a second point 3402 as a point different from the first point 3401 of the object 3301. The camera body 3 acquires a second coordinate (second position information) 3502 based on the position information in the Z-axis direction and focal length information about the second point 3402 and the object 3301, and stores it in the object memory 1012. The camera body 3 then detects edges 3404 and 3405 of the object 3301. The object-edge detecting method is well known, and thus a description thereof will be omitted. The camera CPU 15 estimates a third point 3403 from the detected edges 3404 and 3405 so as to perform reverse tilt imaging (miniature imaging), and acquires (calculates) a third coordinate (third position information) 3503 while referring to the information about the first coordinate 3501 and the second coordinate 3502.

Next, as illustrated in FIG. 9B, the camera CPU 15 drives the second lens unit 22, the sixth lens unit 26, and the eighth lens unit 28 so that only the first coordinate 3501, the second coordinate 3502, and the third coordinate 3503 are in focus, thereby constructing a focal plane. More specifically, only the object 3301 is in focus, and the other objects 3302, 3303, and 3304 are out of focus, thereby making miniature imaging available.

The user can perform tilt imaging simply by specifying two points to be in focus without specifying a third point, and thus can acquire improved convenience of tilt imaging.

In this embodiment, a single object 3301 is selected, but the user may select a plurality of objects. This embodiment sets only the range of the object 3301 to be in focus, but is not limited to this example, as long as the third coordinate is set so that reverse tilt imaging can be acquired. In this embodiment, the points are designated by the user, but this embodiment is not limited to this example, and the points may be designated on a surface having a certain range. For example, the points may be designated within a range of a focus detecting frame for zone autofocus (AF), and any other points may be designated as long as the coordinates can be calculated.

As described above, the control apparatus (camera CPU 15 or lens CPU 9) according to each embodiment includes an acquiring unit (function as the acquiring unit 9a) and a determining unit (function as the control unit 9b). The acquiring unit acquires first position information (first coordinate(s)) and second position information (second coordinate(s)) based on the user's instruction. The determining unit determines the focal plane 501 based on the first position information, the second position information, and third position information (third coordinates) that is not designated by the user. According to each embodiment, the user can construct a desired object plane simply by designating two points. Thereby, the desired imaging can be achieved, the work time can be reduced, and the convenience of tilt imaging can be improved.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that the disclosure is not limited to the example embodiments. The scope of the following claims is to be accorded the broadest interpretation so as to encompass all such modifications and equivalent structures and functions. For example, the focal plane may be constructed from the first position information, the second position information, and information that is not specified by the user and is information before it becomes the third position information.

Each embodiment can provide a control apparatus, an image pickup apparatus, a lens apparatus, a control method, and a storage medium, each of which can improve the convenience of tilt imaging.

What is claimed is:

1. A control apparatus that is used for a camera system that includes an image pickup apparatus including an image sensor, and a lens apparatus including an optical system including at least one optical member configured to tilt a focal plane relative to an imaging surface of the image sensor, the control apparatus comprising:
a processor configured to:
acquire first position information and second position information based on an instruction by a user, and
construct the focal plane from the first position information, the second position information, and information that is not specified by the user.

2. The control apparatus according to claim 1, wherein the information that is not specified by the user is third position information.

3. The control apparatus according to claim 2, wherein the processor is configured to determine the third position information based on image data output from the image sensor.

4. The control apparatus according to claim 3, wherein the processor is configured to determine the third position information based on object information detected from the image data.

5. The control apparatus according to claim 4, wherein the object information includes at least one of information about a type of an object, a range of the object, or an edge of the object.

6. The control apparatus according to claim 5, wherein the processor is configured to determine the third position information based on the range of the object corresponding to the first position information or the second position information so as to widen an in-focus range of the object.

7. The control apparatus according to claim 5, wherein the processor is configured to determine the third position information based on an imaging scene.

8. The control apparatus according to claim 7, wherein the imaging scene is determined based on the image data output from the image sensor.

9. The control apparatus according to claim 8, wherein the imaging scene is determined based on the object information detected from the image data.

10. The control apparatus according to claim 7, wherein the imaging scene is determined based on a mode set by the user.

11. The control apparatus according to claim 2, wherein the processor is configured to determine the third position information based on at least one of information about a focal length, a focus position, or an aperture value.

12. The control apparatus according to claim 2, wherein the processor is configured to determine the third position information while changing an aperture value.

13. The control apparatus according to claim 2, wherein the processor is configured to:
determine a rotation axis based on the first position information and the second position information, and
rotate the focal plane around the rotation axis by changing the third position information.

14. The control apparatus according to claim 1, wherein the processor is configured to control driving of a drive unit configured to drive the optical member that tilts the focal plane relative to the imaging surface of the image sensor, or a focus member configured to perform focusing.

15. The control apparatus according to claim 13, wherein the processor is configured to rotate the focal plane so as to include a focal plane that minimizes or maximizes a moving amount of the optical member configured to tilt the focal plane relative to the imaging surface of the image sensor.

16. The control apparatus according to claim 14, wherein the drive unit drives the optical member to a predetermined position in a case where the processor cannot determine the third position information.

17. The control apparatus according to claim 14, wherein the drive unit changes the focal plane within a movable range of the optical member in a case where the processor cannot determine the third position information.

18. The control apparatus according to claim 14, wherein the processor is configured to issue an alert to the user in a case where the processor cannot determine the third position information or in a case where the driving of the drive unit exceeds a movable range of the optical member.

19. The control apparatus according to claim 2, wherein the first position information, the second position information, and the third position information are three-dimensional position information.

20. An image pickup apparatus comprising:
an image sensor; and
the control apparatus according to claim 1.

21. An image pickup apparatus according to claim 20,
wherein the optical member includes a first optical member and a second optical member which are movable in a direction orthogonal to an optical axis,
wherein both the first optical member and the second optical member have positive refractive power or negative refractive power, and
wherein a tilt effect is generated by moving the first optical member and the second optical member in opposite directions, and a shift effect is generated by moving the first optical member and the second optical member in the same direction.

22. The image pickup apparatus according to claim 20,
wherein the optical member includes a first optical member and a second optical member which are movable in a direction orthogonal to an optical axis,
wherein the first optical member and the second optical member have refractive powers of different positive and negative signs, and
wherein a tilt effect is generated by moving the first optical member and the second optical member in the same directions, and a shift effect is generated by moving the first optical member and the second optical member in opposite directions.

23. A lens apparatus comprising:
an optical system; and
the control apparatus according to claim 1.

24. A control method comprising the steps of:
acquiring first position information and second position information based on an instruction by a user, and
determining a focal plane based on the first position information, the second position information, and information that is not specified by the user.

25. A non-transitory computer-readable storage medium storing a program that causes a computer to execute the control method according to claim 24.
